(19) United States
(12) Patent Application Publication
(10) Pub. No.: US 2016/0258450 A1
(43) Pub. Date: Sep. 8, 2016

(54) CONTROL APPARATUS

(71) Applicant: HYDAC FILTERTECHNIK GMBH, Sulzbach/Saar (DE)

(72) Inventors: Sascha Alexander BIWERSI, Mettlach (DE); Marcus HETTIGER, Saarlouis (DE); Marcus Simon SPECKS, St. Ingbert (DE); Christoph STOENNER, St. Ingbert (DE); Marcus Karl PFEIFFER, Voelklingen (DE); Erik LAUTNER, Berlin (DE)

(21) Appl. No.: 15/026,263

(22) PCT Filed: Sep. 24, 2014
(86) PCT No.: PCT/EP2014/002583

§ 371 Date: Mar. 31, 2016

(30) Foreign Application Priority Data
Oct. 15, 2013 (DE) 10 2013 017 093.1

(51) Int. Cl. F15B 13/042; F15B 13/08; F15B 13/02; F15B 13/04; F15B 20/00; F15B 21/04

(52) U.S. Cl. CPC F15B 13/042; F15B 20/008; F15B 21/042; F15B 13/026; F15B 13/0402; F15B 13/0803; F15B 2211/6355; F15B 2211/65

(57) ABSTRACT

The invention relates to a control device, in particular for hydraulically controlling components of mobile working machines, consisting of at least one pressure supply connection (P) and a tank or return connection (T) in addition to two user connections (A, B) and control and/or regulating valves (10, 14, 16, 18) which are connected between the individual connections (P, T, A, B), in addition to two control lines (C, Z) which can control at least one of the control and/or regulating valves. Said invention is characterized in that a modular-type functional block (24, 26) is connected to at least one of the control lines (C, Z).

The invention concerns a control device, in particular for the hydraulic control of components of mobile machines, comprising at least one pressure supply connection and one tank or return connection as well as two load connections, and control and/or regulating valves connected between the individual connections, as well as two control lines that are able to control at least one of the control and/or regulating valves.

The document DE 42 30 183 C2 discloses a control device for hydraulic motors comprising at least one directional control valve, which may be connected via a supply line to a pump acting as pressure supply device, via a discharge line to a tank or return connection and via at least one output line to a hydraulic motor, with a supply line regulator disposed in the supply line, with a control line that is applied with a load-dependent control pressure that may be connected to the output line via a load sensor, disposed in the directional control valve, where the load sensor may be activated directionally-dependent, and with at least one relief line that leads from the control line via the directional control valve to the discharge line, where at least one safety valve is disposed in the relief line, where the safety valve may be activated into an open position when a predetermined load limit or movement limit is reached, in which the relief line in the directional control valve may be switched into the open position depending on direction and synchronous with the respective activated load sensor.

Because the safety valve in the known solution is disposed in a section of the relief line that is located between the port of the directional control valve and the discharge line, the section of the relief line that contains the safety valve remains depressurised until the safety valve is used for the monitoring of the movement direction of the hydraulic motor that is assigned to it. Thus the known solution ensures that different safety valves may be defined for each movement direction independently.

Based on the prior art, and whilst retaining the above described advantages, it is the object of the invention to further improve the known control device in such a way that its functional range is increased and thus an increased functional reliability is also achieved. This object is met by a control device with the characteristics of claim 1 in its entirety.

Due to the fact that, according to the characterising part of claim 1, a modular-type function block is connected to at least one of the control lines, further control and regulating tasks may be solved and an increase in functional reliability of the overall control device may be achieved depending on the design of the function block. For the average person skilled in the art of such hydraulic control devices it is surprising that, given a suitable design of the modular function block, the design may be reengineered through multiple further arrangements and thus also increase the functional reliability of existing control devices.

In a preferred embodiment of the control device according to the invention, provision is made that the function block is connected to a specific load-sensing line at its inlet port. The known pressure-limiting and shutdown functions for the load-sensing signal usually consider only the sectionally relevant load-sensing pressures A and B of the output or load connections present in this section. With the function block solution according to the invention it is possible to lead out the signal sent from the previous sections to this section, and the signal sent to the next section (before and after a sectional two-way valve), and to manipulate it with the function block accordingly. Considering the ever increasing safety requirements that are demanded, a person skilled in the art is now provided with additional design options for control devices of this kind.

It is of particular advantage to configure the function block employed as a pressure limiting valve, for example, and to control a load-sensing line LP with the control pressure, whereas in another also preferred embodiment the function block is provided with an electromagnetically operable directional control valve, which receives on its input port the pressure from another load-sensing line LS.

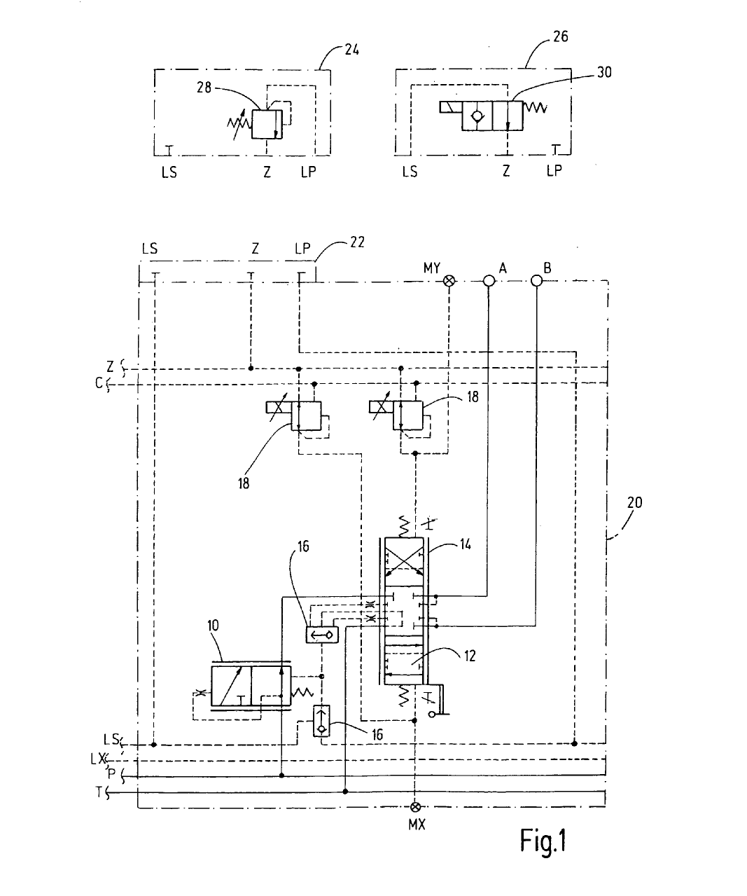

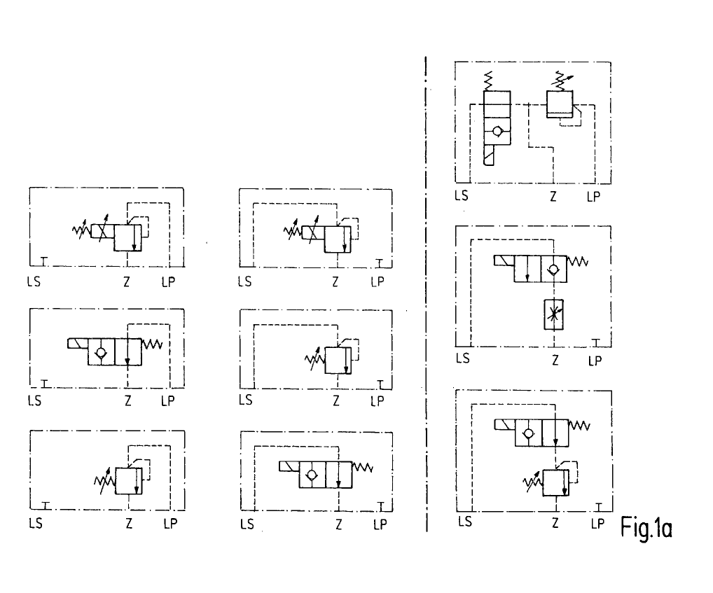

In a further preferred embodiment of the control device according to the invention it is provided that the function block employed is connected to one of the control lines of the control device. This way it is possible to compensate for a possible failure of a pressure reducing valve or a possible failure of an electro-proportional pressure control valve, which are commonly used as control and/or regulating valves in such control devices, which clearly increases the functional reliability of control devices of this kind. Thus a modular system with regard to the functional reliability of the hydraulic pilot control according to DIN EN ISO 13849 in hydraulically operating machines is created. Further functional blocks that may be employed advantageously are depicted in FIG. 1a.

It is also particularly surprising to the average person skilled in the art when designing such control devices that the respective function block can be utilised, when appropriately designed, to heat the fluid volume flow of an entire hydraulic circuit. Particularly in winter, or when the hydraulic control device is used in very cold regions, the heating of the oil volume flow makes sense to prevent malfunctions.

Further advantageous design characteristics are the subject of the other sub-claims.

The control device according to the invention will now be explained in detail by way of different exemplary embodiments. Typical hydraulic control circuits depict in principle (not to scale) in

FIG. 1, 1a, 1b, 2, 3a, 3b, 4a, 4b and 5 various embodiments of the control device according to the invention.

Where connection points, lines or valves are indicated in the hydraulic control circuits, they will not be explained in detail since they are part of the common nomenclature of this field.

The representation according to FIG. 1 concerns a control device in particular for the electro-hydraulic control of components in mobile machines, which are not shown here in detail. The control device shown comprises a pressure supply connection P as well as a tank or return connection T and, moreover, two load connections A, B to which a hydraulic load, for example in form of a power cylinder or in form of a hydraulic motor may be connected. Shown, moreover, are two control lines C and Z as well as load-sensing lines LS, LX and LP besides the associated load-sensing connections. Amongst other items, a so-called individual pressure compensator 10 is used as control and regulating valve of the control device, which is disposed upstream of the control spool 12 of a directional control valve 14, which may be designed as a proportional pressure control valve, for example. Moreover, two two-way valves 16 are employed as well as two electro-proportional pressure control valves 18, which control the control spool 12 of the directional control valve 14 in its shifted position at the outlet side on opposing ends. The control device is designed in form of a valve block 20 and is provided on at least one of its sides with a flange 22 for the purpose of connecting different modular function blocks 24, 26.

The load-sensing signal in conjunction with the individual pressure compensator 10, which is disposed upstream of control spool 12 has, in the instance of volume-controlled mobile valves, a significant influence on their functional characteristics. If, for example, the load-sensing signal is limited to a certain set value through a pressure relief valve, the individual pressure compensator 10 through its closing action ensures that the load volume decreases continually when this value is reached. If the load-sensing signal is not limited to a set pressure but is fully balanced towards the tank connection T the individual pressure compensator 10 remains in its closed position. When the control spool 12 moves, none of the fluid is able to flow via the individual pressure compensator 10 and thus via the control spool 12 towards the loads that are each connected to the load connections A, B. Thus the operation is disabled by the pressure supply device P, for example a hydraulic pump, in the direction of the loads that are connected to the load connections A, B. It is readily conceivable that the manipulation of the load-sensing signal is of great significance with respect to the safety concerns in machine design. Integrated into the individual spool sections, the individual overpressure limitation of the load-sensing signal for the load connections A and B is standard from today's perspective. Besides other possible pressure limiting functions, electrically operated shutoff valves are also prior art and are described, for example, in DE 42 30 183 C2.

The known pressure-limiting and shutoff functions for the load-sensing signal only consider the load pressures A and B of the output or load connections of this section. The signal that is present at this section from the previous section, and the signal transmitted to the next section (upstream and downstream of the sectional two-way valve) is made available externally, according to the invention, and may be manipulated there as required.

As shown in FIG. 1, using the LP load-sensing connection with its associated line it is possible to limit all previous sections with only a single pressure limiting valve 28 (mechanically, electrically activated or electro-proportional) instead of up to two per section. The prerequisite is that all load connections of the previous sections are limited to the same low system pressure. Furthermore it is possible to shut off all previous sections with only a single 2/2-way valve 30. Via the load-sensing line LS and the associated LS connection it is possible to achieve the same manipulative range of functions as with the load-sensing line LP; the only exception is that the load-sensing signal of the section associated with this connection is also taken into consideration.

As depicted in FIG. 1, the load-sensing lines LP and/or LS with their respective connections may either be part of a flange 22 of the valve block 20 for the control device, or it may be implemented as part of the usual threaded connections. According to the diagram in FIG. 1, the function block 24 contains the pressure limiting valve 28 to be connected, and the other function block 26 contains the directional control valve 30. The lines LS, Z and LP shown connected to the function blocks 24, 26 must be connected in a fluid-conducting manner with the corresponding connections LS, Z and LP in flange 22 to ensure functional reliability when in use. When using this design the control line Z is optional and may, as depicted in FIG. 1, be used as internal oil overflow line Z, or it may lead into the tank line T. In addition to the connections LP and/or LS the connections LA, LB and LR (FIG. 1b) may also be made externally available, depending on the machine design. FIG. 1b depicts a correspondingly changed drawing, which is otherwise the same design as that of FIG. 1 but omits the function blocks 24, 26 to simplify the drawing.

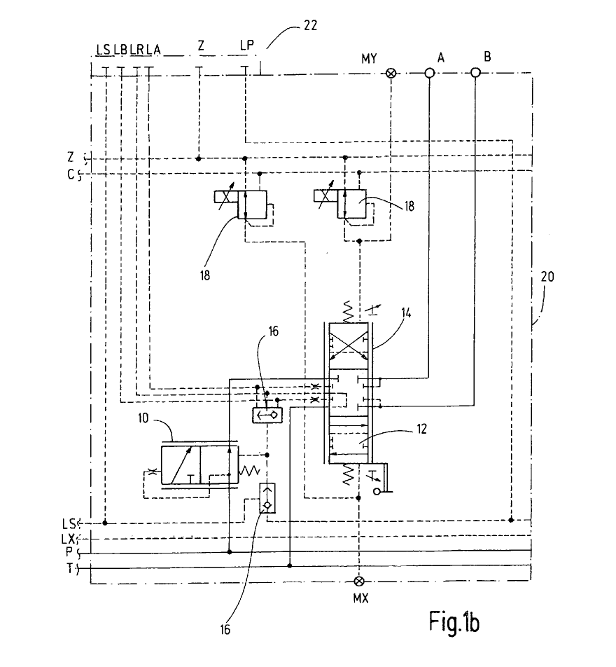

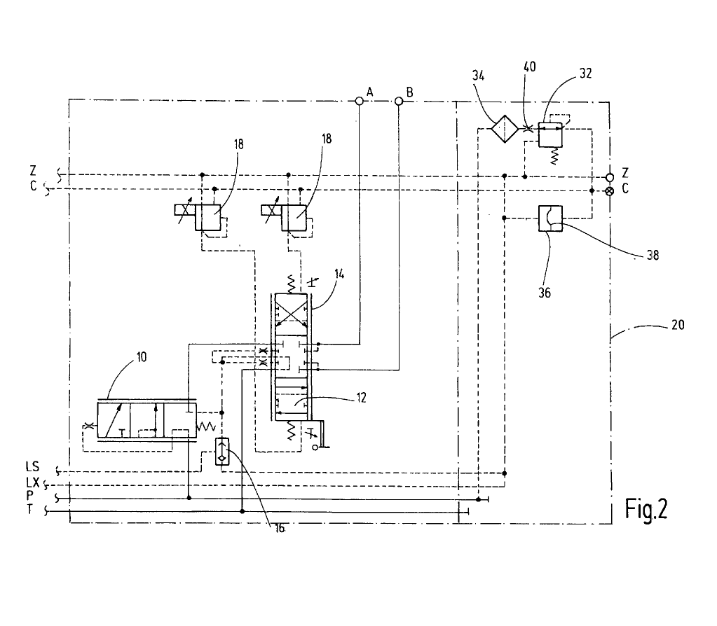

As is also shown in FIG. 1a, further function blocks (framed in dashed lines) with their valve assembly components that correspond to common hydraulic circuit diagrams, may be connected via the connections LS, LP and Z to global control devices as shown, for example, in FIGS. 1 and 1b as described previously, in order to achieve, in this manner, changed functions for the control device and to increase the modularity of the overall concept. The left-hand side of FIG. 1a depicts individual modules as function components, and the opposite right-hand side shows combinations of modules that consist of multiple valve function elements in a function block to be connected. Further logic circuits with or without other modules can also be achieved for the load-sensing lines LA, LB and LR (cf. FIG. 2).

Moreover, with the described function blocks according to the invention a design addressing the functional reliability of the pilot pressure of the hydraulic pilot-controlled main spool 12 of the directional control valves 14 described so far can also be achieved.

The prior art teaches to utilise a hydraulic auxiliary force in hydraulic pilot-controlled directional control valves 14 so that the control element, regularly in form of the control spool 12, is moved into a desired position. The auxiliary force or pilot pressure may be applied independently from outside, or via an internal control/regulating circuit, to the opposing ends of the control spool 12. The commonly used maximum pressures are between 15 and 25 bar. To ensure a constant control or regulating accuracy respectively, care must be taken in hydraulic circuits for mobile equipment that, due to the dynamic pressure patterns, the electro-proportional control valves receive a defined and constant supply pressure. This is why the pump pressure is reduced from the current working pressure to a defined value using an internal pressure reducing valve 32, or an external supply pump (not shown) is used. In most cases the pilot control circuits are, in terms of stress resistance, designed for this low pressure level.

Considering the possibilities of failure in this pilot control circuit, it becomes apparent that not only the pressure reducing valve 32 can fail but also the individual electro-proportional control valves 18 for the respective control spool sides. If, for example, the pressure reducing valve 32 seizes, the high-pressure side will be connected to the low-pressure side. The potential for a dangerous situation is very high. If, on the other hand, a control valve 18 seizes in its control position, one control spool side would be permanently exposed to a pilot control pressure. An uncontrollable machine operation would be the consequence. If in this instance the low-pressure supply cannot be shut off the emergency operation by hand lever also no longer certain. Today's state of the art primary measures include, amongst others, certain design principles for the individual components. Since contamination is still today the most common reason for malfunctions, protective strainers or filter devices 34, as depicted in an exemplary manner in FIG. 2, disposed in fluid flow direction upstream of the pressure reducing valve 32 as well as, if necessary, upstream of the control valves 18, are also part of the other primary protective mechanisms. Secondary measures that may be used can be additional pressure limiting valves (not shown).

To create a cost-effective alternative to the respective secondary-measure pressure limiting valve, a further function block 36 was created for the design of the control device, which is depicted as a valve block 20. One fundamental disadvantage of pressure limiting valves is that the activation of the valve is not necessarily recognisable by the machine operator. That means to be able to detect the activation of the pressure limiting valve and thus the malfunction of the pressure reducing valve, a pressure switch or pressure sensor would be required in addition to a pressure limiting valve. This creates significant additional costs.

To avoid those additional costs, a safety device against overpressure is employed inside the function block 36 in the control device according to FIG. 2 instead of the known pressure limiting valve. In the exemplary embodiment according to FIG. 2, said safety device against overpressure takes the form of a rupture disc 38 of the commonly used type. If the admissible pressure upstream of the control valves 18 is exceeded, the rupture disc 38 is destroyed and, with the aid of an inlet nozzle 40 that is disposed upstream of the pressure reducing valve 32, the pressure is fully relieved upstream of the control valves 18, in particular via the control line C. Controlling the valve spool 12 of the directional control valve 14, and thus controlling the operation of the loads via the control valves 18, is no longer possible. Via a commonly used manual lever action (not shown), the machine connected to the control device can still be operated and moved out of a dangerous situation if necessary.

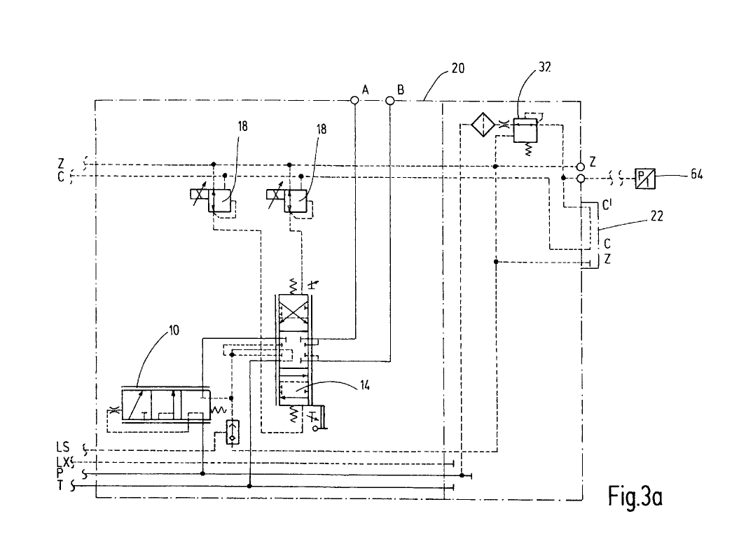

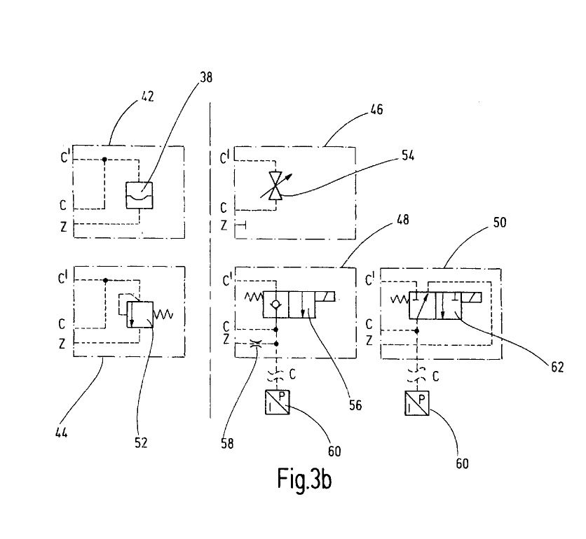

With the device according to the invention it is therefore possible to immediately recognise the malfunction without the aid of electronic devices, and by using the manual lever actuation the machine can still be brought into a “safe state”. As part of the function block 36, the rupture disc 38 may be integrated either into the flange plate or connection plate 22 or directly into an end plate of the valve block 20 of the control device. In developing this thought further and to achieve an overall modular system with regard to the functional reliability of a hydraulic pilot control system according to DIN EN ISO 13849 for machines, a predefinable flange design C′, C and Z is specified according to the solution depicted in FIGS. 3a, 3b on the connection or flange plate 22 of valve block 20. From said flange design C′, C and Z the pressure between the pressure reducing valve 32 and the two pressure control valves 18 can be accessed. Moreover, a hydraulic connection C′, C is provided at which the pressure downstream of the pressure reducing valve 32 in fluid flow direction is present.

With the aid of small adaptive valve units in form of further modular-type function blocks 42, 44, 46, 48 and 50 it is now possible to quickly provide different types of safety devices and thus different types of safety levels, and at the same time the cost-intensive variance with regard to additional connection and/or endplates is limited. To compensate for a malfunction of the pressure reducing valve 32, an externally connected function block 42 would be suitable, which comprises the rupture disc 38 as a safety device with respect to pressure. Another possibility would be the employment of the function block 44, which comprises a pressure limiting valve 52.

To compensate for the malfunction of the electro-proportional pressure control valves 18, a manually actuated shutoff unit 54 may be connected via the flange 22 as part of the function block 46 that may be connected. A further option is to connect to the function block 48 an electrically operated 2/2-way valve 56 with relief nozzle 58 and optional pressure monitoring 60 on the secondary side. Moreover, it would be possible to also monitor the switch position of said 2/2-way valve. A further comparable possibility presents itself through the employment of an electrically operated 3/2-way valve 62, which may optionally also be position-monitored, and may be provided with an optional pressure monitor 60 on the secondary side. The unit designed such can be connected via the function block 50 to the flange 22 as already described. The final possibility described here is to provide monitoring of the pressure directly after the pressure reducing valve 32 via the function block 64. Moreover, it should be said that it is basically possible to employ all function blocks, with their exchangeable contents as discussed above, together in a control device or, depending on the required safety functionality, a certain combination thereof may be selected.

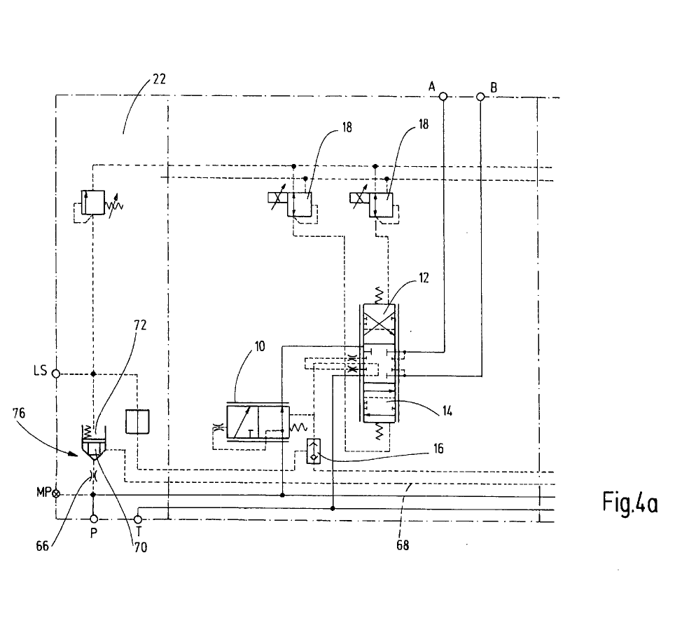

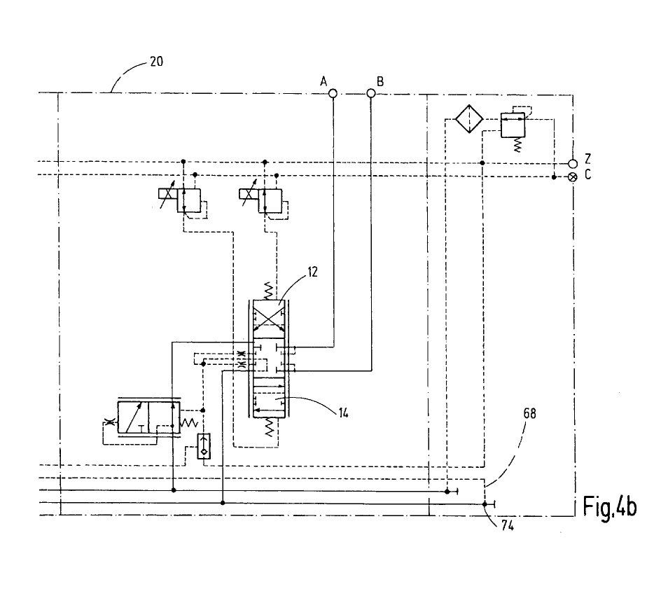

The FIGS. 4a, 4b also concern a hydraulic LS control block of the kind of control device according to the invention with which, via integrated valve arrangements 10, 14, 16 and 18 that operate as control and regulating valve assembly, individual hydraulic loads may be controlled that are connected to the load connections A and B. The hydraulic energy is again provided by a pressure supply facility P, which may be variable or fixed displacement pumps.

In certain mobile machines such as, for example, loading cranes, truck-mounted cranes, concrete pumps etc. it may be that no hydraulic operation is carried out over a longer period of time. This can cause the control device to cool down to ambient temperature, whereas the pressure medium in the overall hydraulic circuit can have a significantly higher temperature due to the operation of separate subsystems. If a control spool 12 of one of the directional control valves 14 is operated now, the warm oil flows into the control spool 12. Since the control spool 12 and its surrounding valve housing may expand differently due to materials used or due to the design and the surrounding flow of the medium at a raised temperature, the respective control or valve spool 12 may seize in the associated housing of the directional control valve 14, especially in winter.

In the solution according to the invention as depicted in FIGS. 4a, 4b the function of heating is only to be activated when it is necessary, that is, when no hydraulic load is operated. Thus heating will occur only if a defined flow rate through the valve block 20 towards the tank connection T is present. If, however, a hydraulic load that is connected to the load connection A, B is operated, no heating will take place so as not to generate unnecessary thermal losses. Moreover, there shall be no manipulation of the pressure-reduced pilot pressure supply of the hydraulic pilot control units.

In commonly used LS systems of mobile hydraulic units, the variable displacement pump maintains in the neutral cycle, that is when no hydraulic loads are in operation, a predefined and set pressure differential, for example 25 bar. In the instance of fixed displacement pumps there is also a certain low pressure present at the control block connection, i.e., the pressure supply connection P, which corresponds to the differential pressure of the neutral cycle circuit (usually >5 bar). That means that in both instances a low pressure can be utilised to let a defined volume flow through the control or valve block 20 for the purpose of heating by using a simple orifice 66.

It is important, however, that the flow is able to pass through all spool sections as per the diagram shown in FIGS. 4a, 4b. If both connections P and T are located in a valve module in form of the valve block 20, said valve block is accessed by an additional passage 68. Said passage 68 is not provided for a specific purpose but may be used for different tasks in the overall modular valve system. In this instance it leads the flow from the connection plate or flange plate 22 through all sections into the endplate, where said flow ends in the T-passage. The T-passages have the fundamental advantage that their cross-section is very large which means that they are able to shed a lot of heat through their large surface area.

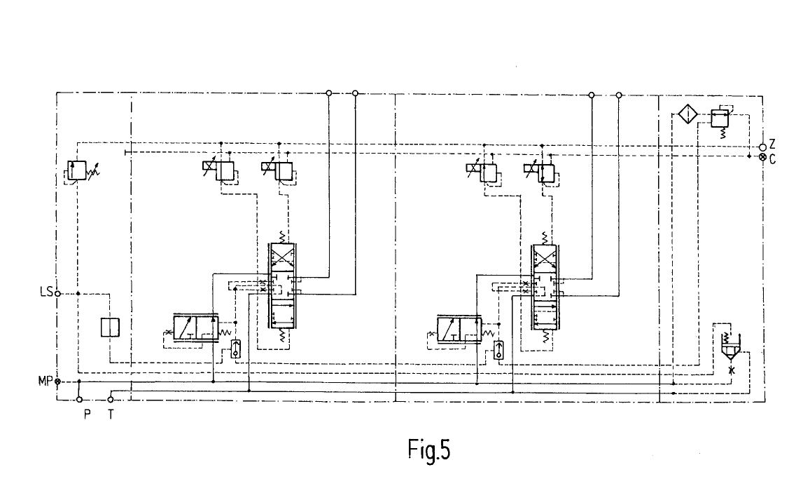

This solution has the further advantage that it would still be operational if the sections were separated for safety reasons from the actual main hydraulic circuit (not shown) through a P-passage shut-off or a deflector. In this instance it is still possible to feed pressure medium from P through the passage 68 into the endplate and from there into the T-passages. If such a P-passage shut-off is not present it would be more effective to make the connection, as per the circuit diagram shown in FIG. 5, via the P-passage into the endplate, then via the nozzle or orifice 66 into the T-passages and back again to the connection or flange plate 22. This would have the advantage of utilising three large passages simultaneously for the purpose of shedding heat.

In the neutral cycle a defined volume flow is fed via the orifice 66 as well as the open shut-off element 70 of a so-called cartridge valve 72 into the additional passage 68, is passed through all sections into the endplate and there directly into the T-passages and thus back to the connection plate 22 and to the tank or return connection T. The transition point 74 for this is shown on the right hand side when viewing FIG. 4. As soon as a load is operated, the load-sensing line (LS chain) sends the load pressure to the connection or flange plate 22 and simultaneously to the closing element 70 of the valve 72. Said valve 72 shuts off the heating function through the additional passage 68 so that no unnecessary thermal losses occur whilst operating the load.

1. Control device, in particular for the hydraulic control of components of mobile machines, comprising at least one pressure supply connection (P) and a tank or return connection (T) as well as two load connections (A, B) and control and/or regulating valves (10, 14, 16, 18) that are connected between the individual connections (P, T, A, B), as well as two control lines (C, Z) that are able to control one of the control and/or regulating valves, characterised in that a modular function block (24, 26, 36, 42, 44, 46, 48, 50, 64, 76) is connected to at least one of the control lines (C, Z).

2. Control device according to claim 1, characterised in that the function block (24, 26) is connected with its input side to a load-sensing line (LP, LS).

3. Control device according to claim 1 or 2, characterised in that one of the control lines is an oil overflow line (Z) and that the function block to be used in this instance is provided with valve elements of different designs, in particular in form of a pressure limiting valve (28) or preferably an electromagnetically operable directional control valve, preferably a 2/2-way valve (30) or an orifice.

4. Control device according to claim 1, characterised in that, when connecting a function block (36, 42, 44, 46, 48, 50, 76) to the respective other control line (C), said control line may optionally comprise the following components:
a safety device (38) against overpressure,
a pressure limiting valve (52),
a manually operable shutoff unit (54),
an electromagnetically operable directional control valve (56, 62), or
an adjustable flow restrictor (66).

5. Control device according to claim 1, characterised in that the discharge end of two control lines (C, Z) may be linked in terms of fluid conduction by means of a pressure reducing valve (32) or by means of a pressure control valve (18).

6. Control device according to claim 1, characterised in that the respective function block (48, 50, 64) is provided with sensors, preferably with a pressure sensor or a switch position monitoring device.

7. Control device according to claim 1, characterised in that the respective function block is connected within a valve block (20) as an integrated component.

8. Control device according to claim 1, characterised in that the respective function block may be connected as a standardised modular unit to a standard flange design (22) of the valve block (20).

9. Control device according to claim 1, characterised in that one of the control and/or regulating valves is a pressure compensator, in particular an individual pressure compensator (10).

10. Control device according to claim 1, characterised in that one of the control and/or regulating valves is a multi-port spool valve (14) at which the load connections (A, B) are connected to the output side in a fluid-conducting manner.
